(19) United States
(12) Patent Application Publication
(10) Pub. No.: US 2007/0251310 A1
(43) Pub. Date: Nov. 1, 2007

(54) Method of confirming a pressure alert in a pressure-monitoring system

(75) Inventor: Jean-Pierre Pompier, Enval (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNQUE S.A.,, GRANGES-PACCOT (CH)

(21) Appl. No.: 11/785,855

(22) Filed: Apr. 20, 2007

(30) Foreign Application Priority Data
Apr. 21, 2006 (FR) 06/03694

(51) Int. Cl. G01M 17/02

(52) U.S. Cl. 73/146

(57) ABSTRACT

A vehicle's tire pressure is monitored such that an actual pressure (Pₘ) measured within the tire is compared to a set pressure (P_{cTm}) which has been corrected for the measured value of the temperature (Tₘ) in order to trigger a pressure alert in the event of a pressure leak. If the tire is cooling, the pressure alerts are stopped if the variation temperature per unit of time (a negative value in a cooling tire) is less than a threshold temperature drift value (also a negative value). Thus, the pressure alerts are stopped when the tire cools at a rapid rate, indicating that the tire is not moving.

This application claims priority under 35 U.S.C. §119 to Application Serial No. 06/03694 filed in France on Apr. 21, 2006, the entire contents of which is incorporated by reference.

### BACKGROUND

The invention relates to pressure-monitoring devices and methods which are used in tires.

These methods and the computational algorithms used by these devices are usually based on the real-time monitoring of the value of the pressure measured in the tire in which the measured pressure value is compared with a given set pressure corresponding to the use pressure recommended by the tire manufacturer.

Most frequently, these methods and the computational algorithms also comprise a real time measurement of the temperature. This is because it is known that, during use, the tire will heat up according to the load and speed conditions which it experiences.

Under these conditions, considering that the volume enclosed in the cavity of the tire is constant, it is possible, in a first approximation, to correct the set pressure for the measured value of the temperature according to the ideal gas law, according to which the ratio

$$\frac{P}{T}$$

is equal to a constant K which is representative of the number of moles of gas introduced into the volume of the tire chamber upon inflation.

Thus, the set pressure P_{cTm} at a measured temperature Tₘ is equal to the initial set pressure P_{cT0} multiplied by the measured temperature Tₘ and divided by the temperature T₀, measured during the inflation operation, namely:

$${P}_{cTm} = \frac{{P}_{cT 0} \times {T}_{m}}{{T}_{0}}$$

Algorithms for monitoring the inflation pressure are described, by way of example, in publication EP 0 315 885-A1 (corresponding to Hebert U.S. Pat. No. 4,893,110), which describes a method based on measuring the temperature and the pressure which makes it possible to evaluate a number of moles of air contained in the cavity of the tire, or alternatively in publication EP 0 786 361-A1 (corresponding to Chamussy et al. U.S. Pat. No. 5,895,846), which describes a method particularly well suited to detecting slow leaks.

These different methods are based on the simultaneous measurement of the temperature Tₘ and the pressure Pₘ, and make it possible to give the user of the vehicle good indications about the pressure of the tires fitted on his vehicle, and to generate alerts when rapid or slow leaks are likely to occur therein.

It has however been observed that these systems, under certain circumstances, issue false alerts which may cause the user to react erroneously.

Thus, when the vehicle goes from a use phase to a stop phase it may happen that an abnormal pressure alert will be given by the monitoring system when no actual air leak can be detected.

The main reason behind these anomalies derives from the fact that, in the cooling phase which follows the operating phase, the temperature measured by the temperature sensor located in the monitoring device measures a temperature Tₘ which is higher than the actual temperature Tᵣ inside the chamber of the tire.

This is because, during this cooling period, the thermal inertia of the sensor which are linked to the location thereof, the position of the temperature probe relative to the heat flows, the coefficients of exchange with the surroundings, are all factors liable to produce a deviation between the measured temperature Tₘ and the actual temperature Tᵣ of the chamber.

It follows that calculating the set pressure P_{cTm} corrected for the value of the measured temperature Tₘ provides a value greater than the value of this parameter would be if the calculation had been performed with the actual temperature Tᵣ. A pressure alert is then liable to be triggered when the deviation between the measured pressure Pₘ, which changes according to the actual temperature Tᵣ of the chamber, and the corrected set pressure P_{cTm} crosses one of the predetermined threshold values.

The object of the invention is to provide a method which makes it possible to avoid these false alerts for a tire which is cooling, i.e., when the tire temperature is dropping.

### SUMMARY OF INVENTION

The method according to the invention is characterized in that the sending of pressure alerts is neutralized (stopped) when the variation in temperature per unit of time

$$\frac{Δ {T}_{m}}{Δ t}$$

for a cooling tire is less than a given (threshold) temperature drift value.

### DETAILED DESCRIPTION OF A PREFERRED EMBODIMENT

For better understanding of the subject of the invention, it will be noted that the variation in temperature per unit of time relating to a drop in temperature is for a cooling tire always is a negative value, as is the threshold temperature draft value. By way of example, a threshold temperature drift value of −2° C./hr is appropriate for a large-sized tire of construction-vehicle type. Thus, if the actual rate of temperature variation in a cooling tire of that type were −4° C./hr, then the pressure alerts would be neutralized, because the value is −4 is less than the value −2.

When the measured temperature drops rapidly, it can be deduced from this, without risk of error, that the vehicle is at a standstill. The alerts which occur during this cooling period thus stand every chance of being false alerts and are therefore not transmitted by the system.

Furthermore, if it were to turn out that an actual, slow pressure leak took place effectively during this cooling phase, it would inevitably be detected when the temperature stops dropping significantly or when the vehicle is restarted.

In case a rapid pressure leak develops during the pressure alert-stoppage period, it is desirable that a pressure alert be sent, i.e., that the neutralization of the pressure alert be lifted. That is accomplished by monitoring the deviation between the measured pressure Pm and the set pressure P_{cTm}, corrected for the value of the measured temperature Tm. If this deviation (ΔP=Pm_{-pcTm}) exceeds a given limit pressure threshold, the insufficient-pressure alert is issued even if the variation in temperature per unit of time

$$( \frac{Δ T}{Δ t} )$$

in the cooling tire is less than the threshold temperature draft value. This additional logical step makes it possible to prevent the vehicle from being able to start off again at zero, or very low, pressure owing to the neutralization of the alert linked to the stoppage period, at the risk of causing the tire to deteriorate during the first rotations of the wheel of the vehicle.

This additional logical step makes it possible to prevent the vehicle from being able to start off again at zero, or very low, pressure owing to the neutralization of the alert linked to the stoppage period, at the risk of causing the tire to deteriorate during the first rotations of the wheel of the vehicle.

The drift limit value of the temperature may be determined as a function of the size and the average climatic conditions of use of the tire.

As noted earlier by way of example, a threshold temperature draft value of −2° C./hr is appropriate for a large-sized tire of construction-vehicle type. A threshold temperature draft value of −8° C./hr is suitable in the case of a small-volume passenger-vehicle tire.

Thus, depending on the applications, the drift value of the temperature is generally between −1° C./hour and −10° C./hour.

The threshold value of the pressure deviation ΔP=Pₘ−P_{cTm} is determined as a function of the pressure at which it is considered that the road-holding of the vehicle may be seriously degraded to the point of adversely affecting the safety thereof, or alternatively that the tire is capable of experiencing degradation, which itself is also detrimental to safety.

This method of eliminating false alerts by specific monitoring of the change in the temperature over time can thus supplement existing methods of monitoring the pressure without any particular difficulty.

What is claimed is:

1. A method of monitoring a tire for pressure leaks, in which a pressure (Pₘ) measured within the chamber of the tire is compared with a set pressure (P_{cTm}) corrected for the measured value of the tire temperature (Tₘ) for detecting a pressure leak and triggering the sending of a pressure alert, wherein the sending of a pressure alert is neutralized when the variation in temperature per unit of time
$$( \frac{Δ Tm}{Δ t} )$$
in a cooling tire is less than a predetermined threshold temperature drift value.

2. A method according to claim 1, wherein the neutralization of the pressure alert is lifted when the difference between the measured pressure (Pₘ) and the set pressure (P_{cTm}) is greater than a predetermined threshold value.

3. A method according to claim 2 wherein the threshold temperature drift value is between −1° C./hr and −10° C./hr.

4. A method according to claim 2 wherein the threshold temperature drift value is approximately −2° C./hr.

5. A method according to claim 1 wherein the threshold temperature drift value is between −1° C./hr and −10° C./hr.

6. A method according to claim 1 wherein the threshold temperature drift value is approximately −2° C./hr.

7. An apparatus for monitoring a tire for pressure leaks according to claim 1, including an algorithm for detecting when
$$( \frac{Δ Tm}{Δ t} )$$
is less than the threshold temperature drift value.

8. A tire pressure monitoring apparatus according to claim 7 wherein the algorithm detects when the difference between the measured pressure (Pₘ) and the set pressure (P_{cTm}) is greater than a predetermined threshold value, in order to lift the neutralization of the pressure alert.
